(19) United States
(12) Patent Application Publication
(10) Pub. No.: US 2023/0043009 A1
(43) Pub. Date: Feb. 9, 2023

(54) A METHOD FOR PREPARING ELECTRO-CONDUCTIVE SILICONE ELASTOMER ARTICLE

(71) Applicant: ELKEM SILICONES SHANGHAI CO., LTD., Shanghai (CN)

(72) Inventors: Yuanzhi YUE, Shanghai (CN); Liya JIA, Shanghai (CN)

(21) Appl. No.: 17/790,489

(22) PCT Filed: Dec. 31, 2019
(86) PCT No.: PCT/CN2019/130390

§ 371 Date: Jun. 30, 2022

(51) Int. Cl. B29C 64/112; C08G 77/08; C08G 77/12; C08G 77/20; C08G 77/14; C08K 3/36; C08K 3/04; C08K 9/02; C08K 9/04

(52) U.S. Cl. CPC B29C 64/112; C08G 77/08; C08G 77/12; C08G 77/14; C08G 77/20; C08K 3/36; C08K 3/042; C08K 9/02; C08K 9/04; B33Y 10/00; C08K 2201/001; C08K 2201/004

(57) ABSTRACT

The invention relates to a method of additive manufacturing an object using a 3D printing apparatus, in which at least one layer or part of at least one layer is formed by an addition-crosslinking electro-conductive silicone composition comprising :
(A) at least one organopolysiloxane compound A comprising, per molecule at least two C₂- C₆ alkenyl radicals bonded to silicon atoms,
(B) at least one organohydrogenopolysiloxane compound B comprising, per molecule, at least two hydrogen atoms bonded to an identical or different silicon atom,
(C) at least one catalyst C comprising at least one metal from the platinum group or the compound thereof,
(D) at least one reinforcing silica filler D,
(E) at least one thixotropic agent which is selected from compounds having epoxy group, (poly)ether group, and/or (poly)ester group, organopolysiloxane having an aryl group and mixtures thereof;
(F) at least one electro-conductive filler F, which is selected from nickel coated carbon, preferably graphite, graphene or mixtures thereof;
(G) optionally at least one crosslinking inhibitor G.

### TECHNICAL FIELD

The invention relates to a method for additive manufacturing a three dimensional electro-conductive elastomer article by using an additive manufacturing material comprising an addition-crosslinking electro-conductive silicone composition.

### BACKGROUND OF THE INVENTION

Additive manufacturing (AM) techniques, is also called 3D printing, which have been used in various fields, especially healthcare, automotive, robots or aerospace etc. The 3D model is obtained via computer-aided design (CAD), which is translated into physical objects by 3D printing processes. The printing process can meet customized requirements and have higher efficiency. At present, different materials such as metal, polymers or ceramic can be printed via different techniques. However, most of polymers based on Fused Deposition Modelling (FDM) are thermoplastic materials with a glass transition temperature above room temperature. These materials can be flowable liquid under heating at higher temperature for extrusion or jetting, then become solid at room temperature. Or some polymers can be cured via UV-curing method. These polymers can be manufactured via Stereo lithography Appearance (SLA) or Digital Light processing (DLP) technique. However, the polymers with a glass transition temperature below room temperature, such as polysiloxane and polysloxane based materials, cannot be printed via FDM because of its flowability at room temperature. The suitable 3D printing method for silicones and silicone-based materials can be found in previous study.

WO2017114440 relates to the electrically conductive rubber obtained by curing the carbon fiber-containing organosilicon composition and its uses especially as electrically-conductive elements in fields of electronics, automobiles, aerospace, high-speed railway, communication, electric power, medicine and wearable intelligent devices, due to electro-conductive and electromagnetic shielding function;

With miniaturization, such as mobile phones, handheld electronic device (Personal Digital Assistant, PDA), PC (Personal Computer, PC) card, a conventional conductive rubber by the actual production process and manufacturing cost constraints, cannot meet the came into being in small size, complexity requirements shield case structure, forming a conductive rubber dispensing technology to comply with this requirement.

Combining electrical-conductive silicon rubber and 3D printing technology will help realize more function and supply even more wide applications.

General solutions have been proposed. WO2017089496, WO2017081028, WO2017121733 teach that the print head technical parameters compatible with the thixotropic properties of the material to be printed, it is possible to obtain satisfactory printing results. And both used one or more compounds selected from epoxy group-functional compound, (poly) ether group-functional compound and (poly) ester group-functional compound as thixotropic agent to adjust and improve the thixotropic properties. Which also include inhibitors, heat stabilizers, solvents, plasticizers, color pigments, sensitizers, photo initiators, adhesion promoters, fillers, conductivity additives etc. WO2017144461 discloses a process, which can keep shape of silicone composition via partially cured layer with heating per printing layer. For silicone composition with electroconductivity property, due to the introduction of metallic fillers, more complex situation will appear to keep good shape during 3D printing. Examples of electrical-conductive fillers include metal particles, metal oxide particles, metal-coated metallic particles (such as silver-plated nickel), metal coated non-metallic core particles (such as silver coated talc, or mica or quartz) and a combination thereof. Metal particles may be in the form of powder, flakes or filaments, and mixtures or derivatives thereof.

However, all these references fail to reveal the influence of the electro-conductive fillers and specific reinforcing fillers on the thixotropic property of the additive manufacturing material, especially those containing the silicone composition. There still exists the need to develop a new way to improve the thixotropic property of the additive manufacturing material which is important for avoiding collapse or deformation during printing and providing needed electrical conductivity and good mechanical performance for printed articles.

### SUMMARY OF THE INVENTION

It is an object of the present invention to provide a method that allows a time efficient production of an electro-conductive three-dimensional elastomer article, in particular a 3D printing or additive manufacturing method.

It is also an object of the present invention to provide a method for additive manufacturing of electro-conductive elastomer articles with reduced or even no trend to collapse or deformation of the layers at room temperature before complete curing.

It is also an object of the present invention to provide the use of a special addition-crosslinking electro-conductive silicone composition for a time efficient production of an electro-conductive element or part of it in electronics, automobiles, aerospace, high-speed railway, communication, electric power, medicine and wearable intelligent devices. The advantages brought out by using such a specific additional crosslinking electro-conductive silicone composition in the additive manufacturing process include such as good processability, regulable mechanical properties, good stability and so on.

It is also an object of the present invention to obtain 3D elastomer parts with excellent manufacture accuracy and improved electrical conductivity, which can be regulated with regard to the electrical conductivity in a broader range (e.g., volume resistivity ranging from 0.001 to 1×10¹⁰ Ω·cm).

It is also an object of the present invention to obtain 3D elastomer parts with better mechanical properties and electrical conductivity adjustable according to demand.

### DETAILED DESCRIPTION OF THE INVENTION

In one aspect, the present invention relates to a method of additive manufacturing an object using a 3D printing apparatus, comprising the steps of:
1) applying an additive manufacturing material on a substrate with a 3D printer selected from an extrusion 3D printer or a material jetting 3D printer to form a first layer,
2) optionally applying onto the first layer one or more subsequent layer(s) of the additive manufacturing material, wherein the compositions of the material of the first and subsequent layers are kept the same or different from each other, and
3) allowing the first and optional subsequent layers to crosslink, optionally by heating, to obtain an elastomer article,
characterized in that at least one layer or part of at least one layer is formed by an addition-crosslinking electro-conductive silicone composition comprising :
(A) at least one organopolysiloxane compound A comprising, per molecule at least two C₂- C₆ alkenyl radicals bonded to silicon atoms,
(B) at least one organohydrogenopolysiloxane compound B comprising, per molecule, at least two hydrogen atoms bonded to an identical or different silicon atom,
(C) at least one catalyst C conprising at least one metal from the platinum group or the compound thereof,
(D) at least one reinforcing silica filler D,
(E) at least one thixotropic agent which is selected from compounds having epoxy group, (poly)ether group, and/or (poly)ester group, organopolysiloxane having an aryl group and mixtures thereof;
(F) at least one electro-conductive filler F, which is selected from nickel coated carbon, preferably nickel coated graphite, graphene or mixtures thereof;
(G) optionally at least one crosslinking inhibitor G.

In another aspect, the present invention relates to an elastomer article produced by the inventive method.

In still another aspect, the present invention relates to the use of the addition-crosslinking electro-conductive silicone composition as disclosed below for producing an electro-conductive element or part of it in electronics, automobiles, aerospace, high-speed railway, communication, electric power, medicine and wearable intelligent devices.

It is to the credit of the inventors to have found that the above objects could be solved by using the inventive addition-crosslinking electro-conductive silicone composition that are crosslinkable through addition reactions. Such an electro-conductive silicone composition has the adequate thixotropic properties which are suitable for 3D printers, in particular for an additive manufacturing process using an additive manufacturing material containing a silicone composition as printing material, and is helpful to decrease or avoid collapse or deformation of the objects at room temperature before complete curing and have electrical conductivity adjustable according to demand after curing.

The electro-conductive fillers will bring about certain thixotropic property, and various electro-conductive filler make different levels of impact on thixotropy of the additive manufacturing material, especially the additive manufacturing material containing or consisting of the silicone composition. Furthermore, the reinforcing silica filler is usually also required to help get good balance of electro-conductivity and thixotropy for 3D printing, and important for the better mechanical properties after curing. It is found in particular preferable to use the reinforcing silica with an amount in the range from 0.5 wt% to 40 wt%, preferably from 2 wt%to 20 wt%and more preferably from 3 wt%to 15 wt%of the total composition. The combination of thixotropic agent and silica is usually also necessary to achieve thixotropic status of the material for 3D printing processes. In different systems, different structure and surface properties of electrically conductive fillers result in different network with thixotropic agent and silica, which shows different thixotropic performance.

It has been surprisingly found that the better results could be obtained by adding into an addition crosslinking silicone composition a specific combination comprising reinforcing silica fillers and the conductive fillers selected from nickel-coated carbon and graphene. It has been also found that a further improvement of the thixotropy and a regulable conductivity may be achieved by adjusting the weight ratio of reinforcing silica fillers to electro-conductive fillers within the inventive specified scope, i.e. from 0.0001 to 100, preferably from 0.001 to 50, more preferably from 0.01 to 10, and most preferably from 0.05 to 3.

The term “thixotropic properties” refers to not only the fact of the viscosity index which is commonly used and disclosed as the ratio between the viscosity at slow shear rate to the viscosity at high shear rate for a non-Newtonian body. It is also related to the speed rise of the viscosity when decreasing the shear rate.

Therefore, a parameter “thixotropic index” is herein introduced to assess the thixotropic property and it is expressed as the ratio between the viscosity at slow shear rate to the viscosity at high shear rate for a non-Newtonian body. The measurement for this parameter is described below in the experimental part of the instant application.

In the first aspect, the present invention is a method for additive manufacturing an elastomer article. In the present disclosure, there are in principle no special limitations to the additive manufacturing material and it may be consisting mainly of the polymer material, especially curable silicone composition. The skilled person in the 3D printing technical field knows well which material may be used as the additive manufacturing material. Preferably, in the instant invention, the additive manufacturing process refers in particular to a method using the silicone compositions as additive manufacturing material. The silicone compositions suitable for additive manufacturing process are well known per se and in principle may be any curable silicone composition that has the siloxane units based backbone and can be used for producing a silicone elastomer article, such as the liquid silicone rubber (LSR) which has been already used widely.

The suitable silicone composition may be curable chemically via condensation or addition crosslinking reactions. In one exemplary embodiment, such a curable silicone composition usually comprises:
(A) a polyorganosiloxane polymer containing the siloxane unit represented by the formula (S-1) and optionally formula (S-2)

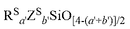

in which
R^{S} is a reactive group like hydroxyl, alkoxy, alkenyl, and alkynyl groups,
Z^{S} may be the same or different and represent a monovalent non-reactive hydrocarbon radical having for example from 1 to 30 carbon atoms, preferably selected from alkyl and aryl groups,
a′ is 1, 2 or 3, b′ is 0, 1 or 2 and the sum of a′ + b′ is 1, 2 or 3;

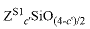

in which:
c′ = 0, 1, 2 or 3,
Z^{S1} may be identical or different and represent a monovalent non-reactive hydrocarbon radical having for example from 1 to 30 carbon atoms, preferably selected from alkyl and aryl groups,
(B) a cross-linking organosilicon compound having at least 2 silicon-bonded reactive groups;
(C) a catalyst capable of promoting the reaction between component (A) and component (B).

In the first step, a first layer of the additive manufacturing material, preferably a silicone composition, is applied, i.e. printed on a substrate such that the layer is formed on the substrate. The substrate is no limited and may be any substrate. The substrate can support the 3D article during the process of manufacturing, for example a substrate plate of the 3D printer. The substrate can be rigid or flexible and can be continuous or discontinuous. The substrate may itself be supported, for example by a substrate table or plate, such that the substrate needs not to have rigidity. It may also be removable from the 3D article. Alternatively, the substrate can be physically or chemically bonded to the 3D article. In one embodiment, the substrate may be in silicone.

In the optional second step, one or more subsequent layer(s) is/are formed by applying the additive manufacturing material, preferably a silicone composition, on the first layer with an extrusion 3D printer or a material 3D jetting printer. The extrusion 3D printer and the material 3D jetting printer may be the same as or different from the extrusion 3D printer or a material 3D jetting printer utilized in step 1).

The compositions of the additive manufacturing material forming the first and one or more subsequent layers may be kept the same as or different from each other.

The layers formed by the additive manufacturing may have any shape and any dimension. Each layer can be continuous or discontinuous.

In the application of the first layer and optional one or more subsequent layers on the substrate, it is important in the present invention that at least one layer or part of at least one layer is formed by the addition-crosslinking electro-conductive silicone composition as described below. In one embodiment of the present invention, all layers are formed by the addition-crosslinking electro-conductive silicone composition. Also, in some applications, only one layer formed by the inventive addition-crosslinking electro-conductive silicone composition may be sufficient.

In the third step, by allowing these layers to complete crosslinking, optionally by heating, an elastomer article is obtained. Crosslinking can be completed at ambient temperature. Usually ambient temperature refers to a temperature between 20 and 25° C.

Heating may be used to accelerate the crosslinking or curing of the layers. A thermal cure after printing can be done at a temperature between 50 and 200° C., preferably between 60 and 100° C., in order to achieve complete cure or crosslinking faster.

In this document the term “layer” may relate to the layers at any stage of the method, first or previous or subsequent layer. The layers can be each of various dimensions, including thickness and width. Thickness of the layers can be uniform or may vary. Average thickness is related to the thickness of the layer immediately after printing.

In an embodiment, each of the layers independently may have a thickness of from 0.1 to 5000 µm, preferably from 1 to 2000 µm, more preferably from 10 to 1000 micrometers and most preferably from 50 to 800 micrometers.

In a particular embodiment, no energy source as heat or radiation is applied during or between steps 1) to 2) prior to the printing of at least 10, preferably 20 layers.

### 3D Printing Disclosure

3D printing is generally associated with a host of related technologies used to fabricate physical objects from computer generated, e.g. computer-aided design (CAD), data sources.

This disclosure generally incorporates ASTM Designation F2792 - 12a, “Standard Terminology for Additive Manufacturing Technologies Under this ASTM standard,

“3D printer” is defined as “a machine used for 3D printing” and “3D printing” is defined as “the fabrication of objects through the deposition of a material using a print head, nozzle, or another printer technology.”

“Additive manufacturing (AM)” is defined as “a process of joining materials to make objects from 3D model data, usually layer upon layer, as opposed to subtractive manufacturing methodologies. Synonyms associated with and encompassed by 3D printing include additive fabrication, additive processes, additive techniques, additive layer manufacturing, layer manufacturing, and freeform fabrication.” Additive manufacturing (AM) may also be referred to as rapid prototyping (RP). As used herein, “3D printing” is generally interchangeable with “additive manufacturing” and vice versa.

“Printing” is defined as depositing of a material, here a silicone composition, using a print head, nozzle, or another printer technology.

In this disclosure “3D or three dimensional article, object or part” means an article, object or part obtained by additive manufacturing or 3D printing as disclosed above.

In general, all 3D printing processes have a common starting point, which is a computer generated data source or program which may describe an object. The computer generated data source or program can be based on an actual or virtual object. For example, an actual object can be scanned using a 3D scanner and scan data can be used to make the computer generated data source or program. Alternatively, the computer generated data source or program may be designed from scratch.

The computer generated data source or program is typically converted into a standard tessellation language (STL) file format; however other file formats can also or additionally be used. The file is generally read into 3D printing software, which takes the file and optionally user input to separate it into hundreds, thousands, or even millions of “slices.” The 3D printing software typically outputs machine instructions, which may be in the form of G-code, which is read by the 3D printer to build each slice. The machine instructions are transferred to the 3D printer, which then builds the object, layer by layer, based on this slice information in the form of machine instructions. Thicknesses of these slices may vary.

An extrusion 3D printer is a 3D printer where the material is extruded through a nozzle, syringe or orifice during the additive manufacturing process. Material extrusion generally works by extruding material through a nozzle, syringe or orifice to print one cross-section of an object, which may be repeated for each subsequent layer. The extruded material bonds to the layer below it during cure of the material.

In one preferred embodiment, the method for additive manufacturing a three-dimensional elastomer article uses an extrusion 3D printer. The additive manufacturing material like silicone compositions are extruded through a nozzle. The nozzle may be heated to aid in dispensing the silicone composition.

The average diameter of the nozzle defines the thickness of the layer. In an embodiment, the diameter of the layer is comprised from 5 to 5000 µm , preferably from 10 to 2000 µm and most preferably from 50 to 1000 µm.

The distance between the nozzle and the substrate is an important parameter to assure good shape. Preferably it is comprised from 60 to 150 %, more preferably from 80 to 120 % of the nozzle average diameter.

The silicone composition to be dispensed through the nozzle may be supplied from a cartridge-like system. The cartridge may include a nozzle or nozzles with an associated fluid reservoir or fluids reservoirs. It is also possible to use a coaxial two cartridges system with a static mixer and only one nozzle. Pressure will be adapted to the fluid to be dispensed, the associated nozzle average diameter and the printing speed.

Because of the high shear rate occurring during the nozzle extrusion, the viscosity of the silicone compositions is greatly lowered and so permits the printing of fine layers.

Cartridge pressure could vary from 1 to 20 bars, preferably from 2 to 10 bar and most preferably from 2.5 to 8 bar. An adapted equipment using aluminum cartridges shall be used to resist such a pressure.

The nozzle and/or build platform moves in the X-Y (horizontal plane) to complete the cross section of the object, before moving in the Z axis (vertical) plane once one layer is complete. The nozzle has a high XYZ movement precision such as 10~300 µm. After each layer is printed in the X, Y work plane, the nozzle is displaced in the Z direction only far enough that the next layer can be applied in the X, Y work place. In this way, the object which becomes the 3D article is built one layer at a time from the bottom upwards.

As disclosed before, the distance between the nozzle and the previous layer is an important parameter to assure good shape. Preferably, it should be comprised from 60 to 150 %, preferably from 80 to 120 % of the nozzle average diameter.

Advantageously, printing speed is comprised between 0.1 and 100 mm/s, preferably between 1 and 50 mm/s to obtain the best compromise between good accuracy and manufacture speed.

“Material jetting” is defined as “an additive manufacturing process in which droplets of build material are selectively deposited.” The material is applied with the aid of a printing head in the form of individual droplets, discontinuously, at the desired location of the work plane (Jetting). 3D apparatus and a process for the step-by-step production of 3D structures with a printing head arrangement comprising at least one, preferably 2 to 200 printing head nozzles, allowing the site-selective application where appropriate of a plurality of materials. The application of the materials by means of inkjet printing imposes specific requirements on the viscosity of the materials.

In a material 3D jetting printer one or a plurality of reservoirs are subject to pressure and being connected via a metering line to a metering nozzle. Upstream or downstream of the reservoir there may be devices which make it possible for multicomponent addition-crosslinking silicone compositions to be homogeneously mixed and/or to evacuate dissolved gases. One or a plurality of jetting apparatuses operating independently of one another may be present, to construct the elastomer article from different addition-crosslinking silicone compositions, or, in the case of more complex structures, to permit composite parts made from silicone elastomers and other plastics,

Because of the high shear rate occurring in the metering valve during the jetting metering procedure, the viscosity of such silicone compositions is greatly lowered and so permits the jetting metering of very fine microdroplets. After the microdrop has been deposited on the substrate, there is a sudden reduction in its shear rate, and so its viscosity climbs again. Because of this, the deposited drop rapidly becomes of high viscosity again and permits the shape-precise construction of three-dimensional structures.

The individual metering nozzles can be positioned accurately in x-, y-, and z-directions to permit precisely targeted deposition of the silicone rubber drops on the substrate or, in the subsequent course of formation of shaped parts, on the silicone rubber composition which has already been placed and which optionally has already been crosslinked.

Contrary to other additive manufacturing methods, it is unnecessary to carry out the inventive method in an irradiated or heated environment to initiate the curing after each layer is printed to avoid the collapse of the structure. Thus, the irradiation and heating operation may be optional.

Typically, the 3D printer utilizes a dispenser, e.g. a nozzle or print head, for printing the particular curable silicone composition. Optionally, the dispenser may be heated before, during, and after dispensing the silicone composition. More than one dispenser may be utilized with each dispenser having independently selected properties.

In one embodiment, this method can use support material to build the object. If the object is printed using support material or rafts, after the printing process is complete, they are typically removed leaving behind the finished object.

### Post-Process Options

Optionally, the resulting articles may be subjected to different post-processing regimes. In an embodiment, the method further comprises the step of heating the three-dimensional silicone article. Heating can be used to expedite cure. In another embodiment, the method further comprises the step of further irradiating the three-dimensional silicone article. Further irradiation can be used to expedite cure. In another embodiment, the method further comprises both steps of heating and irradiating the three-dimensional silicone article.

Optionally, post-processing steps can greatly improve the surface quality of the printed articles. Sanding is a common way to reduce or remove the visibly distinct layers of the model. Spraying or coating the surface of the elastomer article with a heat or UV curable RTV or LSR silicone composition can be used to get the right smooth surface aspect.

A surfacing treatment with a laser can also be done.

For medical applications, a sterilization of the final elastomer article can be obtained by heating the object at >100° C. or in an UV oven.

### Addition-Crosslinking Electro-Conductive Silicone Composition

The addition-crosslinking electro-conductive silicone compositions in individual layers may be the same as or different from one another. In the inventive method, the addition-crosslinking electro-conductive silicone compositions forming at least one layer or part of it is the inventive silicone composition containing the components (A) to (G) as indicated above. In an embodiment, all applied layers are formed by the inventive addition-crosslinking electro-conductive silicone compositions.

### Organopolysiloxane Compound A

The organopolysiloxane compound A comprises, per molecule, at least two C2-C6 alkenyl radicals bonded to silicon atoms, with the alkenyl groups being at any position of the main chain of polysiloxane, for example, at ends or in the middle of the molecular chain or both.

Preferably, the organopolysiloxane compound A comprises:
(I) at least two siloxy units of Formula (I-1),

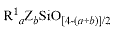

wherein
R¹ which may be identical or different, represents a linear or branched C2-12, preferably C2-6 alkenyl group, most preferably vinyl or allyl,
Z represents identically or differently a univalent hydrocarbyl group with 1 to 30, preferably 1 to 12 carbon atoms, preferably selected from C1-8 alkyl groups including alkyl groups optionally substituted with at least one halogen atom, and chosen from the group formed by methyl, ethyl, propyl, 3,3,3-trifluoropropyl,
a is 1 or 2, b is 0, 1 or 2, and the sum of a and b is 1, 2 or 3,
and optionally (II) other siloxy units of Formula (I-2)

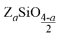

wherein
Z has the meanings as indicated above and c is 0, 1, 2 or 3.

In a preferred embodiment, Z can be selected from methyl, ethyl, propyl, 3,3,3-trifluoropropyl, phenyl, xylyl and tolyl and the like. Preferably, at least 60 mol%(or expressed by number) of group Z is methyl.

In a preferable embodiment, in formula (I-1) a=1 and a+b=2 or 3 and in formula (I-2) c=2 or 3.

These organopolysiloxane compound A may have a linear, branched or cyclic structure.

When they are linear polymers, they are essentially formed from siloxyl units “D” chosen from the group formed by the siloxyl units R₂SiO_{2/2}, RZSiO_{2/2} and Z₂SiO_{2/2}, and from siloxyl units “M” chosen from the group formed by the siloxyl units R₃SiO_{½}, RZ₂SiO_{½}, R₂ZSiO_{½} and Z₃SiO_{½}. The symbols R and Z are as described above.

As examples of end units “M”, mention may be made of trimethylsiloxy, dimethylvinylsiloxy or dimethylhexenylsiloxy groups.

As examples of units “D”, mention may be made of dimethylsiloxy, methylvinylsiloxy, methylbutenylsiloxy, methylhexenylsiloxy, methyldecenylsiloxy or methyldecadienylsiloxy groups.

Without impairing the purpose of the present invention, the molecular chain may further contain branched siloxy units, but in the proportion preferably not exceeding 10%, more preferably not exceeding 5% in the organopolysiloxane compound A.

The organopolysiloxane compound A may be monomer, oligomer or polymer. In one embodiment, they preferably have a dynamic viscosity from about 1 to 10000000 mPa.s at 25° C., generally from about 200 to 1000000 mPa.s at 25° C. It can also be a gum with greater viscosity. In the present application, all viscosities relate to dynamic viscosities values and can be measured for example in a known manner using a Brookfield viscometer at 20° C. If the viscosity is too high to be measured by Brookfield instrument, it can be measured by Ubbelohde viscometer.

The organopolysiloxane compound A may have the alkenyl content of 0.0001~40 wt%., preferably 0.001 35 wt%, more preferably 0.0130 wt%, based on the total weight of organopolysiloxane compound A.

When they are cyclic organopolysiloxanes, they are formed from siloxyl units “D” having the following formulae: R₂SiO_{2/2}, Z₂SiO_{2/2} or RZSiO_{2/2}, which may be of the dialkylsiloxy, alkylvinylsiloxy or alkylsiloxy type. Examples of such siloxyl units have already been mentioned above. Said cyclic organopolysiloxane compound A is not limited monomer, oligomer or polymer. In one embodiment, they preferably have a viscosity from about 1 to 500000 mPa.s at 25° C.

### Organohydrogenpolysiloxane Compound B

According to a preferred embodiment, the organohydrogenopolysiloxane compound B is an organopolysiloxane containing at least two hydrogen atoms per molecule, bonded to an identical or different silicon atom, so as to perform crosslinking reaction with organopolysiloxane compound A.

According to the present invention, the SiH group in organohydrogenopolysiloxane compound B can be at any position of the main chain of polysiloxane, for example, at ends or in the middle of the molecular chain or both.

Advantageously, the organohydrogenopolysiloxane compound B is an organopolysiloxane comprising:
(i) at least two siloxyl units and preferably at least three siloxyl units having the following formula:

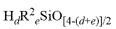

Wherein
R² represents identically or differently a monovalent linear, branched or cyclic alkyl group containing from 1 to 30 carbon atoms, preferably selected from C1-8 alkyl groups including alkyl groups optionally substituted with at least one halogen atom, and from aryl groups, especially C6-20 aryl groups, and chosen from the group formed by methyl, ethyl, propyl, 3,3,3-trifluoropropyl, and
(ii) optionally at least one siloxyl unit having the following formula:

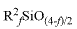

in which:
R² has the meanings as indicated7 above and f is 0, 1, 2 or 3.

In a more preferred embodiment, R² can be selected from methyl, ethyl, propyl, 3,3,3-trifluoropropyl, phenyl, xylyl and tolyl.

The organohydrogenopolysiloxane compound B may be formed solely from siloxyl units of formula (II-1) or may also comprise units of formula (II-2). It may have a linear, branched or cyclic structure.

Examples of siloxyl units of formula (II-1) are especially the following units: H(CH₃)₂SiO_{½}, and HCH₃SiO_{2/2}.

When they are linear polymers, they are essentially formed from:
siloxyl units “D” chosen from the units having the following formulae R²₂SiO_{2/2} or R²HSiO_{2/2}, and
siloxyl units “M” chosen from the units having the following formulae R²₃SiO_{½} or R²₂HSiO_{½}.

These linear organopolysiloxanes may be oils with a dynamic viscosity from about 1 to 1000000 mPa.s at 25° C., generally from about 1 to 50000 mPa.s at 25° C. or preferably from about 5 to 10000 or 5000 mPa.s at 25° C.

Examples of organohydrogenopolysiloxane compound B include linear or cyclic compounds, for example, dimethyl polysiloxane having hydrogenated dimethyl siloxy end group, copolymer having (dimethyl)(hydrogenmethyl) polysiloxane units having trimethyl siloxy end group, copolymer having (dimethyl)(hydrogenmethyl) polysiloxane units having hydrogenated dimethyl siloxy end group, hydrogenated methyl polysiloxane having trimethylsiloxy end group, and cyclic hydrogenated methyl polysiloxane.

The organohydrogenopolysiloxane compound B may be a three-dimensional net-like organohydrogensiloxane resin containing at least two different units selected from the group comprising or consisting of
units M of formula R'₃SiO_{½},
units D of formula R’₂SiO_{2/2},
units T of formula R'SiO_{3/2} and
units Q of formula SiO_{4/2}, wherein R' represents hydrogen atom or a monovalent hydrocarbonyl group having from 1 to 20 carbon atoms, and
with the proviso that at least one of these siloxane units is the siloxane unit T or Q, preferably Q, and at least one of the siloxane units M, D and T comprises a hydrogen atom.

In one preferred embodiment, the mole ratio of M unit to Q unit in said organohydrogensiloxane resin is from 0.5 to 8 mol/mol, preferably from 0.5 to 6 mol/mol, more preferably from 0.8 to 5 mol/mol.

In another exemplary embodiment, the mass content of SiH is between 0.001 wt% and 70 wt%, preferably between 0.5 wt% and 60 wt% and more preferably between 1.0 wt%and 50 wt%, based on the total weight of component B.

### Catalyst C

Catalyst C comprising at least one metal from the platinum group or the compound thereof. The platinum metal catalyst is well known in organosilicon field and commercially available. In addition to platinum, the platinum group metal can further comprise ruthenium, rhodium, palladium, osmium and iridium. The catalyst can be composed of following components: a platinum group metal or compound thereof or a combination thereof. Examples of such a catalyst include but not limited to: platinum black, chloroplatinic acid, platinum dichloride, reaction product of chloroplatinic acid with monohydric alcohol. Preferably, compounds of platinum and rhodium are used. Usually, the preferred catalyst is platinum.

Some suitable complexes and compounds of platinum are disclosed in, for example, patents US3159601A, US3159602A, US3220972A, EP0057459A, EP0188978A and EP0190530A, and especially a complex of platinum and vinyl organosiloxane as disclosed in, for example, patents US3419593A, US3715334A, US3377432A and US3814730A can be used. All these documents are incorporated in its entirety in the present specification by reference.

The platinum catalyst ought preferably to be used in a catalytically sufficient amount, to allow sufficiently rapid crosslinking at room temperature. Typically, 1 to 10000 ppm by weight of the catalyst are used, based on the amount of Pt atom, preferably 1 to 100 ppm by weight, more preferably 1 to 50 ppm by weight, relative to the total weight of the addition-crosslinking electro-conductive silicone composition.

### Reinforcing Silica Filler D

To allow a sufficiently high mechanical strength, it is advantageous to include in the addition-crosslinking electro-conductive silicone compositions the silica fine particles as reinforcing fillers D, which is preferably at least partly surface treated. Precipitated and fumed silicas and mixtures thereof can be used. The specific surface area of these actively reinforcing fillers ought to be at least 50 m²/g and preferably in the range from 100 to 400 m²/g as determined by the BET method. Actively reinforcing fillers of this kind are very well-known materials within the field of the silicone rubbers. The stated silica fillers may have hydrophilic character or may have been hydrophobized by known processes. Advantageously, the silica reinforcing fillers are subjected to an overall surface treatment. That means at least 50%, more preferably at least 80% or at least 90% of or especially preferably the entirety of the surface of silica reinforcing fillers is preferably hydrophobic treated.

In a preferred embodiment, the silica reinforcing filler is fumed silica with a specific surface area of at least 50 m²/g and preferably in the range from 100 to 400 m²/g as determined by the BET method. Fumed silica that is subjected to hydrophobic surface treatment may be used. In those cases, where a fumed silica that has undergone hydrophobic surface treatment is used, a fumed silica that has been subjected to preliminary hydrophobic surface treatment may be used. Alternatively a surface treatment agent may be added during mixing of the fumed silica with the organopolysiloxane compound A, so that the fumed silica is treated in-situ.

The surface treatment agent may be selected from one or more of the conventionally used agents, such as alkylalkoxysilanes, alkylchlorosilanes, alkylsilazanes, silane coupling agents, titanate-based treatment agents, and fatty acid esters. These surface treatment agents may be used either simultaneously or in order.

The amount of the silica reinforcing filler D in the addition-crosslinking electro-conductive silicone composition is in the range from 0.5 wt% to 40 wt%, preferably 2 wt% to 20 wt% and more preferably 3 wt% to 15 wt% by weight of the total composition. If the amount is less than 1 wt%, the adequate thixotropy may not be obtainable and the collapse may not be noticeably reduced, whereas if exceeding 40 wt%, the actual blending process may become difficult and the electrical conductivity could be poor. More preferred amount as given above will lead to more remarkable improvements in respect to the collapse, deformation, conductivity and processability.

### Thixotropic Agent

The thixotropic agent is used to adjust shear thinning and thixotropic energy of the silicone composition. Shear thinning performance is herein understood as referring to as shear rate increases, and viscosity declines.

In the present invention, the thixotropic agent that is suitable in the inventive addition-crosslinking electro-conductive silicone composition is preferably selected from compounds having epoxy group, (poly)ether group, and/or (poly)ester group, and organopolysiloxane having an aryl group.

Compounds having epoxy group can be any organic compound having at least one epoxy group or epoxy group-functional compound. Examples of organic epoxy-functional compounds include 1,2-epoxypropanol, vinylcyclohexene monoxide, dodecanol glycidyl ether, butyl glycidyl ether, p-tert.-butylphenyl glycidyl ether, 2-ethylhexyl glycidyl ether, glycidyl methacrylate, dicyclopentadiene dioxide, vinylcyclohexene dioxide, butanediol diglycidyl ether, neopentyl glycol diglycidyl ether, 1,6-hexanediol diglycidyl ether, polypropylene glycol diglycidyl ether, trimethylolpropane triglycidyl ether, 3,4-epoxycyclohexylmethyl-3’,4’-epoxycyclohexane carboxylate. Epoxy group-functional compounds can be an epoxidized vegetable oil or a vegetable oil containing epoxy groups, such as epoxidized rapeseed oil, sunflower oil, linseed oil, soybean oil, palm oil, crambe oil, castor oil and vernonia oil, or an epoxidized fatty acid, such as epoxidized oleic acid, petroselinic acid, erucic acid, linoleic acid, linolenic acid, ricinoleic acid, calendic acid, vernolic acid and santalbinic acid.

Preferred epoxy group-functional compounds E1 are epoxy-functional organosilicon compounds comprising or composed of units of formula (III-1)

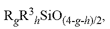

wherein R may be identical or different and denote an H, HO or any desired optionally substituted radical containing from 1 to 40 carbon atoms,
R³ is an optionally halo-substituted, monovalent hydrocarbon radical having from 2 to 20 carbon atoms containing at least one epoxy group CH₂(—O—)CH— or —CH(—O—)CH— and optionally containing O, N, S or P atoms, with the proviso that
g is 0, 1, 2 or 3,
h is 0, 1, 2, 3 or 4,
and (g+h) is ≤ 4.

Examples thereof include epoxy-functional silanes such as 2-(3,4-epoxycyclohexyl)ethyltriethoxysilane, 2-(3,4-epoxycyclohexyl)-ethyltrimethoxysilane, (3-glycidoxypropyl)trimethoxysilane, (3-glycidoxypropyl)triethoxysilane, 5,6-epoxyhexyltriethoxysilane, (3-glycidoxypropyl)methyldimethoxysilane, (3-glycidoxypropyl)-methyldiethoxysilane, (3-glycidoxypropyl)dimethylethoxysilane and tris(glycidoxypropyldimethylsiloxy)phenylsilane.

Further examples of organosilicon compounds include epoxy-functional siloxanes such as bis(2-(3,4-epoxycyclohexyl)ethyl)tetramethyldisiloxane, 1,5-bis(glycidoxypropyl)-3-phenyl-1,1,3,5,5-pentamethyitrisiloxane, (3-glycidoxypropyl)bis(trimethylsiloxy)silane, (3-glycidoxypropyl)pentamethyldisiloxane, 1,3-bis(glycidoxypropyl)tetramethyldisiloxane, glycidoxypropyl-tetramethylcyclotetrasiloxane, glycidoxypropyl-trimethoxy-silylethyl-pentamethylcyclopentasiloxane, glycidoxypropyl-terminated polydimethylsiloxanes, epoxycyclohexylethyl-terminated polydimethylsiloxanes, copolymeric poly(epoxycyclohexylethylmethyl-dimethyl)siloxanes and copolymeric poly(epoxycyclohexylethylmethyl-dimethyl-polyalkyleneoxypropylmethyl)-siloxanes.

Compounds having (poly) ether group may be a polyether-functional organic or organosilicon compound or a mixture of a plurality of such compounds. Preference is given to polyalkylene glycols of the general formula (III-2)

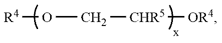

wherein the radicals R⁴ may be identical or different and represent an optionally halo-substituted, monovalent, saturated or unsaturated C₁-C₂₀ hydrocarbon radical optionally containing O, S, N or P atoms, a hydrogen atom, or a monovalent organosilicon radical,
the radicals R⁵ may be identical or different and are a hydrogen atom or a C₁-C₄ hydrocarbon radical, preferably a hydrogen atom or a methyl radical,
x is an integer from 1 to 1000, preferably from 1 to 500 and more preferably 5-100.

Preference is given to polyalkylene glycols having a melting point of less than 100° C., preferably less than 50° C., and particular preference is given to polyalkylene glycols that are liquid at room temperature. The number-average molecular weight of preferred polyalkylene glycols is between 200 and 10,000 g/mol.

Preference is given to polyethylene glycols having a number-average molecular weight of 200 g/mol (PEG 200), about 400 g/mol (PEG 400), about 600 g/mol (PEG 600), and about 1000 g/mol (PEG 1000).

Preference is given to block copolymers of polyethylene glycol (PEG) and polypropylene glycol (PPG) of the PEG-PPG and PEG-PPG-PEG type, e,g. poly(ethylene glycol)-block-poly(propylene glycol)-block-poly(ethylene glycol), preferably having a PEG content of >10% by weight, more preferably having a PEG content of >30% by weight.

Preference is given to polyalkylene-glycol-functional silanes and siloxanes. Examples include bis((3-methyldimethoxy-silyl)propyl)polypropylene oxide, 1,3-(bis(3-triethoxysilyl-propyl)polyethyleneoxy)-2-methylenepropane, bis(3-triethoxy-silylpropyl)polyethylene oxide with 25-30 EO units, 2-(methoxy(pelyethyleneoxy)6-9propyl)dimethylmethoxysilane, 2-(methoxy(polyethyleneoxy)6-9probyl)trimethoxysilane, methoxytriethyleneoxyundecyltrimethoxysilane and bis(3-(trimethoxysilylpropyl)-2-hydroxypropoxy)polyethylene oxide. Examples of polyalkylene-glycol-functional siloxanes may be block and graft copolymers consisting of dimethylsiloxane units and ethylene glycol units.

Compounds having (poly)ester group may be a polyester-functional compound or a carboxylate ester functional compound or mixtures of respective compounds, which can be liquid, amorphous or crystalline. The compounds may be linear or branched.

Preference is given to polyester-functional or carboxylate ester functional compounds having a melting point below 100° C., preferably below 50° C., and particular preference is given to polyester-functional or carboxylate ester-functional compounds that are liquid at room temperature.

The number-average molecular weight of preferred polyester-functional or carboxylate ester-functional compounds is between 200 and 2500 g/mol.

Liquid compounds are preferred.

Suitable polyester-functional compounds are, for example, polyester polyols which can be prepared, for example, from dicarboxylic acids having from 2 to 12 carbon atoms, preferably from 4 to 6 carbon atoms, and polyhydric alcohols. Polyester polyols are generally known to the person skilled in the art and they are available commercially. Polyester polyols containing two or three terminal OH groups are particularly suitable.

Condensation products of w-hydroxycarboxylic acids such as ω-hydroxycaprole acid and preferably polymerization products of lactones, for example optionally substituted ω-caprolactones, can also be used.

Block copolymers of the mentioned compound and mixtures of the above-mentioned compounds can also be used.

Examples of polyhydric alcohols for preparing the polyester polyols include glycols having from 2 to 10, preferably from 2 to 6 carbon atoms, such as, for example, ethylene glycol, diethylene glycol, polyethylene glycol, dipropylene glycol, polypropylene glycol, dibutylene glycol and polybutylene glycol, 1,4-butanediol, 1,5-pentanediol, 1,6-hexanediol, 1,10-decanediol, 2,2-dimethyl-1,3-propanediol, 2-methyl-1,3-propanediol, 1,3-propanediol, dipropylene glycol, 1,4-hydroxymethylcyclohexane, 1,2,4-butanetriol, triethylene glycol, and tetraethylene glycol, and mixture thereof; preferably 1,4-butanediol and/or 1,6-hexanediol.

Examples of dicarboxylic acids for preparing the polyester polyols include for examplealiphatic dicarboxylic acids, such as succinic acid, glutaric acid, adipic acid, suberic acid, azelaic acid and sebacic acid, and aromatic dicarboxylic acids, such as phthalic acid, isophthalic acid and terephthalic acid. The dicarboxylic acids can be used individually or as mixtures, for example in the form of a succinic, glutaric and adipic acid mixture.

Therefore, in one preferred embodiment, the examples of polyester diols include ethanediol polyadipates, 1,4-butanediol polyadipates, ethanediol-1,4-butanediol polyadipates, 1,6-hexanediol neopentyl glycol polyadipates, 1,6-hexanediol-1,4-butanediol polyadipates and polycaprolactones.

In a preferred embodiment, the organopolysiloxane having an aryl group is an organopolysiloxane containing siloxyl units of the formula (III-3):

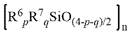

in which
R⁶ and R⁷ is independently from each other selected from hydrogen and an unsubstituted or substituted hydrocarbon group containing from 1 to 30 carbon atoms; where
n is an integer greater than or equal to 1;
p and q are independently 0, 1, 2 or 3; and
p + q = 1, 2 or 3;
provided that the organopolysiloxane having an aryl group contains at least one aryl group directly bonded to Si atom.

In one preferred embodiment, the organopolysiloxane having an aryl group is consisting substantially of siloxyl units of the formula (III-3).

In a preferred embodiment, the hydrocarbon group contains from 1 to 24, preferably 1 to 18, more preferably 1 to 12, such as 2 to 8 carbon atoms. The hydrocarbon group may include such as linear, branched or cyclic alkyl or alkenyl groups and it may be unsubstituted or substituted by one or more halogens and an aryl group, and an aryl group that is unsubstituted or substituted by one or more halogens and C₁-C₆-alkyl groups and contains between 6 and 12 carbon atoms.

The organopolysiloxane having an aryl group is of linear, branched or cyclic structure, and preferably linear. In the linear or branched structure, the organopolysiloxane E4 may be terminated by group -R or -SiR₃ wherein R, independently from each other, has the meaning given for groups R⁶ and R⁷. The skilled person will understand that the aryl group may be present pendent to the main chain of organopolysiloxane or at the end of the chain as a terminated group R or contained in the terminated group -SiR₃.

In a preferred embodiment, the aryl groups may be unsubstituted or substituted by one or more halogens and C₁-C₆-alkyl groups and contain between 6 and 12 carbon atoms. More preferentially they are chosen from the group formed by xylyl, tolyl and phenyl radicals, most preferably phenyl radical.

In a preferred embodiment, in the formula (III-3) above:

n is an integer greater than or equal to 2.

In a preferred embodiment, in the formula (III-3) above:

p and q are independently from each other 1 or 2.

In a preferred embodiment, in the formula (III-3) above:

At least one of groups R⁶ and R⁷ is an aryl group and the others are chosen from the group formed by an alkyl group containing from 1 to 8 carbon atoms, preferably methyl or ethyl group, and an alkenyl radical containing from 2 to 6 carbon atoms, preferably vinyl group.

In a further preferred embodiment, the organopolysiloxane having an aryl group, such as that of formula (III-3), contains at least one aryl group, preferably a phenyl group, and at least one alkenyl group preferably vinyl group.

In a further preferred embodiment, the organopolysiloxane having an aryl group, such as that of formula (III-3), contains at least one aryl group, preferably a phenyl group, and at least one SiH group.

In another preferred embodiment, the organopolysiloxane having an aryl group E4, such as that of formula (III-3), contains at least one aryl group, preferably a phenyl group, at least one alkenyl group preferably vinyl group and at least one SiH group.

In view of the improvement of thixotropic property and compatibility and especially in order further to avoid oil bleeding and improve the transparency which may be very important for the silicone elastomer product, it is advantageous for the organopolysiloxane having an aryl group to contain, in addition to an aryl group, at least one alkenyl group preferably vinyl group or SiH group. Alternative, the organopolysiloxane having an aryl group contains additionally both alkenyl group and Si—H group. The aryl and alkenyl groups and optionally hydrogen may be bonded directly to the same or different Si-atoms, i.e. located in the same or different siloxyl units. Preferably, the alkenyl group, more preferably vinyl group, is a terminated group of the organopolysiloxane chain.

In one advantageous embodiment, the organopolysiloxane having an aryl group may be the organopolysiloxane consisting of the above-mentioned siloxyl units of the formula (III-3) terminated by group -R or -SiR3.

As useful examples of the organopolysiloxane having an aryl group, the compounds of following formulae can be mentioned:

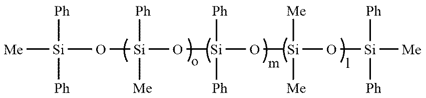

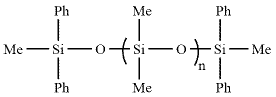

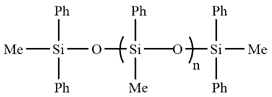

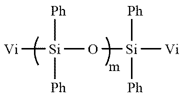

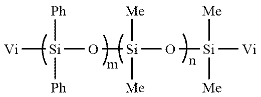

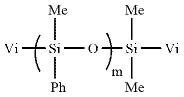

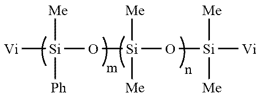

Methods of preparing the organopolysiloxane having an aryl group and preferably an alkenyl group are well known in the art, for example in CN105778102A, CN 108329475A, CN106977723A, CN105778102A, CN101885845A, CN104403105A and CN103012797A.

In the instant invention, the silicone composition comprises 0.3 - 30 wt%, preferably 0.8 - 20 wt%, more preferably 1.0 - 10.0 wt% and most preferably 1.0 - 7.0 wt% of at least one organopolysiloxane having an aryl group with respect to the total weight of the addition-crosslinking electro-conductive silicone composition.

Furthermore, advantageously, the organopolysiloxane having an aryl group has the viscosity ranging from 3 ~ 10 000 000 mPas, preferably ranging from 10 ~ 200 000 mPas, such as 50 ~ 100 000 mPas and 100 ~ 10 000 mPas. The organopolysiloxane having an aryl group has refractive index above 1.405, preferably ranging from 1.41 ~ 1.6, more preferably from 1.43-1.58.

Accordingly, the amount of aryl group is from 2 wt% to 70 wt%, preferably 5 wt% to 62 wt%, and for example 10 wt% to 58 wt%, based on the total weight of organopolysiloxane having an aryl group.

The content of the thixotropic agent in the addition-crosslinking electro-conductive silicone composition according to the invention is from 0.01 wt% to 30 wt%, preferably from 0.05 wt% to 20 wt%, more preferably from 0.20 wt% to 10 wt%, most preferably from 0.5 wt% to 7 wt%.

### Electro-Conductive Filler F

Normally electrically insulating polymers can be made electrically conductive via the addition of electro-conductive fillers, such as carbon fibers, carbon blacks, or metal fibers. In each case, sufficient amount of filler must be added to overcome the percolation threshold so as to arrive at the critical concentration of filler at which the polymer will conduct an electrical current. Beyond this threshold conductivity increases markedly as electro-conductive filler is added. It is believed that at the percolation threshold, uninterrupted chains of conducting particles first appear in the system. The addition of still greater amounts of electro-conductive filler produces a correspondingly higher number of uninterrupted chains and this results in still higher levels of conductivity.

The inventor has found that adding into the matrix of the inventive addition-crosslinking electro-conductive silicone composition reinforcing silica filler and some selected conductive filler in specific weight ratios obtains good balance of thixotropy and regulable conductivity. The weight ratio of reinforcing filler to conductive filler is from 0.0001 to 100, preferably from 0.001 to 50, more preferably from 0.01 to 10, and most preferably from 0.05 to 3.

According to the present invention, the specific electro-conductive fillers F selected from nickel-coated carbon, graphene and mixtures thereof have to be used in the silicone composition to improve the thixotropic properties and processability of the additive material.

The specific two fillers, i.e. nickel-coated carbon and graphene are well known per se in the art and can be available in the market. The nickel-coated carbon include such as nickel-coated carbon fibers, carbon nanotubes or graphite. In the present invention, nickel-coated graphite is found to be preferred.

Furthermore, the inventors have found that in case of nickel-coated carbon, it is more preferable to use it in form of pure particles, pure flakes or pure fibers. That means, it is preferred to use a nickel-coated carbon particle, a nickel-coated carbon flake or a nickel-coated carbon fiber, but not the mixture thereof.

In one preferred embodiment, when the electro-conductive filler F is nickel-coated carbon, the weight ratio of reinforcing silica filler D to electro-conductive filler F in the composition is from 0.0001 to 100, preferably from 0.01 to 10, more preferably from 0.05 to 0.6.

Furthermore, in case of using nickel-coated carbon flake, the average length of electro-conductive filler F may be preferably less than 200 µm, more preferably less than 150 µm to result in the electrical conductivity in a broader range (e.g., volume resistivity ranging from 0.001 to 1×10¹⁰ Ω·cm).

When the electro-conductive filler F is nickel-coated carbon, thixotropic index of the said silicone compositions for additive manufacturing can be higher than 10, preferably higher than 11, more preferably higher than 12.

In another preferred embodiment, in case of graphene used as the electro-conductive filler F, the weight ratio of reinforcing filler D to electro-conductive filler F in the composition is from 0.001 to 100, preferably from 0.1 to 10, more preferably from 0.35 to 1.5.

When the electro-conductive filler F is graphene, thixotropic index of the said silicone compositions for additive manufacturing can be higher than 3, preferably higher than 3.5, more preferably higher than 4.

In addition to the above-discussed electro-conductive fillers, the silicone composition according to the invention can optionally comprise other electro-conductive fillers so as to adjust the overall properties of the composition as desired. Other electro-conductive fillers could be selected from the group of aluminum powder, iron powder, nickel powder, copper powder, silver powder, gold powder, graphite, carbon black, carbon nanotubes, silver coated glass, copper coated glass, silver coated nickel etc.

### Crosslinking Inhibitor G

Crosslinking inhibitors are an optional component. But they are commonly used in addition crosslinking type silicone compositions to slow the curing of the composition at ambient temperature. The crosslinking inhibitor F may be chosen from the following compounds:
acetylenic alcohols such as ethynylcyclohexanol,
tetramethylvinyltetrasiloxane, such as 2,4,6,8-Tetramethyl-2,4,6,8-tetravinylcyclotetrasiloxane
pyridine,
organic phosphines and phosphites,
unsaturated amides, and
alkyl maleates.

These acetylenic alcohols, which are among the preferred hydrosilylation-reaction thermal blockers and described in such as FR-B-1 528 464 and FR-A-2 372 874, have the formula:
(R″)(R‴)(OH)C-C≡CH
in which: R″ is a linear or branched alkyl radical, or a phenyl radical; R‴ is H or a linear or branched alkyl radical, or a phenyl radical; and the radicals R″ and R‴ and the carbon atom in α position to the triple bond may form a ring.

The total number of carbon atoms contained in R″ and R‴ is at least 5 and preferably from 9 to 20. For the said acetylenic alcohols, examples that may be mentioned include:
1- ethynyl-1-cyclohexanol;
3-methyl-1-dodecyn-3-ol;
3,7,11- trimethyl-1-dodecyn-3-ol;
1,1-diphenyl-2-propyn-1-ol;
3-ethyl-6-ethyl-1-nonyn-3-ol;
2-methyl-3-butyn-2-ol;
3-methyl-1-pentadecyn-3-ol; and
diallyl maleate or diallyl maleate derivatives.

In a preferred embodiment, the crosslinking inhibitor is 1- ethynyl-1-cyclohexanol.

To obtain a longer working time or “pot life”, the quantity of the inhibitor is adjusted to reach the desired “pot life”. The concentration of the catalyst inhibitor in the present silicone composition is sufficient to slow curing of the composition at ambient temperature. This concentration will vary widely depending on the particular inhibitor used, the nature and concentration of the hydrosilylation catalyst, and the nature of the organohydrogenpolysiloxane. Inhibitor concentrations as low as one mole of inhibitor per mole of platinum group metal will in some instances yield a satisfactory storage stability and cure rate. In other instances, inhibitor concentrations of up to 500 or more moles of inhibitor per mole of platinum group metal may be required. The optimum concentration for an inhibitor in a given silicone composition can be readily determined by routine experimentation.

Advantageously, the amount of the crosslinking inhibitor F in the addition-crosslinking electro-conductive silicone compositions is in the range from 0.01 wt% to 2 wt% weight, preferably from 0.03 wt% to 1 wt% weight with respect to the total weight of the silicone composition.

The use of the inhibitor is effective to avoid the premature curing of the silicone composition on the tip of the nozzle and subsequent disfiguration of the printed layer.

### Other Components H

The silicone compositions according to the invention may also comprise other additives like a standard semi-reinforcing or packing filler, other functional silicone resins such as silicone resin with vinyl group, non-reactive methyl polysiloxane, pigments, or adhesion promoters.

Non siliceous minerals that may be included as semi-reinforcing or packing mineral fillers can be chosen from the group constituted of carbon black, titanium dioxide, aluminium oxide, hydrated alumina, calcium carbonate, ground quartz, diatomaceous earth, zinc oxide, mica, talc, iron oxide, barium sulfate and slaked lime.

It is desirable in the addition-crosslinking electro-conductive silicone composition that the molar ratio of silicon-bonded hydrogen atoms (Si-H groups) to the sum of the silicon-bonded vinyl groups (Si-Vinyl groups) in whole composition is from 0.5 to 10 mol/mol, preferably from 0.8 to 5 mol/mol, more preferably from 1 to 3 mol/mol.

In a preferable embodiment, the addition-crosslinking electro-conductive silicone composition of the invention comprises, per 100% weight of the silicone composition:
(A) 5-95 wt% of said organopolysiloxane compound A,
(B) at least one said organohydrogenopolysiloxane compound B;
(C) 0.1-500 ppm of said catalyst C,
(D) 1-30 wt%, preferably 3-15 wt.% of said reinforcing silica filler D ,
(E) from 0.01 wt% to 30 wt%, preferably 0.20 wt% to 10 wt%, most preferably from 0.5 wt% to 7 wt% of said thixotropic agent;
(F) at least one said electro-conductive filler F;
(G) optionally at least one said crosslinking inhibitor G,
wherein, the weight ratio of reinforcing silica filler D to conductive filler F in the composition is from 0.0001 to 100, preferably from 0.001 to 50, more preferably from 0.01 to 10, and most preferably from 0.05 to 3.

In another preferable embodiment, the addition-crosslinking electro-conductive silicone composition of the invention comprises, per 100% weight of the silicone composition:
from 20 to 95 wt% of at least one said organopolysiloxane compound A;
from 0.1 to 20 wt% of at least one said organohydrogenopolysiloxane compound B;
from 3 to 15 wt% of at least one said reinforcing silica filler D;
from 0.8-10 wt%, preferably 1-7 wt% of at least one said thixotropic agent;
from 0.1-500 ppm of said catalyst e.g. platinum;
from 0.01 to 2 wt% of at least one said crosslinking inhibitor; and
said electro-conductive filler F;
in which the weight ratio of reinforcing silica filler D and conductive filler F in the composition is from 0.05 to 3.

In a preferred embodiment, the addition-crosslinking electro-conductive silicone compositionhas a dynamic viscosity of 100-50 000 000 mPa.s, preferably 1000-10 000 000 mPa.s, more preferably 5000 ~ 1 000 000 mPa.s.

Preferably, the addition-crosslinking electro-conductive silicone compositions with a thixotropic index of higher than 3 for example higher than 3.5, or higher than 4 depending on different electro-conductive fillers are used to manufacture an article by additive manufacturing.

The crosslinking of the silicone composition starts, even if slowly, as soon as the layer is printed. To avoid collapse or deformation of the objects at room temperature before complete curing, thixotropic properties must be managed so that the thixotropic index falls within the above stated scope.

It should be noted that individual amounts illustrated in the above two preferable embodiments and also in the scopes above-mentioned in the instant application are just exemplary and thus each of them can be arbitrarily combined in any way as is well understood for the skilled person in the art.

### Multi-Part Composition

The composition can be a one-part composition comprising components A to E in a single part or, alternatively, a multi-part composition comprising these components in two or more parts, provided components B, and C are not present in the same part. For example, a multi-part composition can comprise a first part containing a portion of component A and all of component C, and a second part containing the remaining portion of component A and all of component B. In certain embodiments, component A is in a first part, component B is in a second part separate from the first part, and component C is in the first part, in the second part, and/or in a third part separate from the first and second parts. Components D, E and F may be present in a respective part (or parts) along with at least one of components B, or C, and/or can be in a separate part (or parts).

The one-part composition is typically prepared by combining the principal components and any optional ingredients in the stated proportions at ambient temperature. Although the order of addition of the various components is not critical if the composition is to be used immediately, the hydrosilylation catalyst is typically added last at a temperature below about 30° C. to prevent premature curing of the composition.

Also, the multi-part composition can be prepared by combining the components in each part. Combining can be accomplished by any of the techniques understood in the art such as, blending or stirring, either in a batch or continuous process in a particular device. The particular device is determined by the viscosity of the components and the viscosity of the final composition.

In certain embodiments, when the silicone compositions are multipart silicone compositions, the separate parts of the multi-part silicone composition may be mixed in a dispense printing nozzle, e.g. a dual dispense printing nozzle, prior to and/or during printing. Alternatively, the separate parts may be combined immediately prior to printing.

### EXAMPLES

The following examples are intended to illustrate and not to limit the invention.

Addition-crosslinking electro-conductive silicone compositions are prepared and printed using an extrusion 3D printer according with the disclosure.

Raw Materials

Table 1

Raw materials description

| | |
|---|---|
| Raw materials | Chemical description or structure |
| A-1 | Vinyl terminated Polydimethylsiloxane, viscosity: 1500 mPa • s, vinyl content: 0.26 wt% |
| A-2 | Vinyl terminated Polydimethylsiloxane, viscosity: 100000 mPa • s, vinyl content: 0.08 wt% |
| B-1 | Poly(methylhydrogeno) (dimethyl)siloxane with end-chain (α/ω) SiH groups, viscosity:8.5 mPa • s, SiH content: 5.5 wt% |
| B-2 | Poly(methylhydrogeno) (dimethyl)siloxane with SiH groups in-chain and end-chain (α/ω), viscosity:30 mPa • s, SiH content: 7.3 wt% |
| C-1 | Pt catalyst: Platinum(0)-1,3-divinyl-1,1,3,3-tetramethyldisiloxane (Pt content: 10 wt%) |
| D-1 | Treated silica, CAS NO: 68988-89-6 |
| E-1 | Polyethylene glycol monolaurate, CAS NO.: 9004-81-3 |
| E-2 | Epoxy-containing Polydimethylsiloxane, viscosity:350 mPa • s, epoxy content: 11.25 wt% |
| F-1 | Nickel coated graphite flake, average length: 100 µ m, 60% Ni, 40% C, |
| F-2 | Graphene |
| G-1 | Ethynyl-1-cyclohexanol CAS NO.: 78-27-3 |
| | 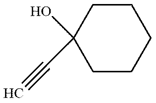 |
| H-1 | Polydimethylsiloxane, viscosity: 50 mPa • s |

### Examples 1-6 and Comparative Examples 1-5

Example 1: 6 parts of D-1 and 57 parts of F-1 were added by three batches into the mixture of 14 parts of α, ω-vinylsiloxane oil A-1, 14.06 parts of α, ω-vinylsiloxane oil A-2 and 3.72 parts of polydimethylsiloxane H-1 with enough agitation. 0.3 parts of inhibitors G-1 was added into the mixture, followed by addition of 2.2 part of Poly(methylhydrogeno) (dimethyl)siloxane B-1 and 0.7 parts of Poly(methylhydrogeno) (dimethyl)siloxane B-2. Then, 2 parts of E-1 was added into the mixture at room temperature under stirring. Finally, 0.02 parts of catalyst C-1 was added to obtain the addition-crosslinking conductive silicone composition.

Examples 2-6 and comparative examples 1-5: carrying out the same preparation process as Example 1 except adjusting various amounts or ratios of different raw materials as shown in tables 2-1 and 2-2.

### 3D Printing Process Based on Curable Method

The printing process is carried out by using ULTIMAKER 2+ equipment (provided by the company Ultimaker). Printing process is as follows:
I. Loading the silicone material into an extruder;
II. Level adjusting the printing platform and setting printing parameters;
III. a. Printing is carried out layer by layer at room temperature, following by a first curing at room temperature for 16 hours and then a second curing in an oven at 150° C. for 1 hour.

### Properties Assessments

The properties assessments on the curable silicone compositions according to the present invention are listed in the tables 2.

### Thixotropic Test

A rotational rheometer (Haake Rehometer) was used to define the thixotropic behavior of samples. A thixotropic test was performed in two parts at room temperature using cone-plate (35 mm, 1°, gap = 52 µm) in order to keep a constant shear rate in sample. The first part was a pre-shear test in order to destroy the material’s microstructure as in 3D printing conditions (3 s at 5 s-1). The second part was a time sweep test in order to define the thixotropic performance of samples. An equivalent shear thinning test was performed to define a “viscosity ratio” which allows users to evaluate the material’s performance in 3D printing. The “ratio” was calculated with the dynamic viscosity at low and high shear rate: 0.5 and 25 s-¹ respectively. A high value of “viscosity ratio” means that material is able to product 3D objects with high quality.

In this method, the addition-crosslinking electro-conductive silicone composition showed the adequate thixotropic properties necessary to avoid collapse or deformation of the objects at room temperature before complete curing. Preferably, the silicone composition was characterized with a “viscosity ratio”, defined as the ratio of the dynamic viscosity at low (0,5 s⁻¹) and high shear rate (25 s⁻¹). When nickel coated graphite flake was used as electrically conductive fillers, the ratio higher than 10 were used to manufacture an article by additive manufacturing. In contrast, the ratio higher than 3 was proper for graphene system.

Hardness: The hardness of the cured sample based on the curable silicone composition was measured at 25° C. according to ASTM D2240. The details of the measuring conditions were listed in the tables 2-1 and 2-2. The cured sample was obtained by precuring at 25° C. for 12 hours, then post curing under 150° C. for 1 hour. Or the cured sample was obtained by directly heating during printing.

Tensile strength and Elongation at break: Tensile strength and elongation at break of the cured sample based on the curable silicone composition were measured at 25° C. according to ASTM D412. The details of the measuring conditions were listed in the tables 2-1 and 2-2. The cured sample was obtained by precuring at 25° C. for 12 hours, then post curing under heating condition for 1 hour. Or the cured sample was obtained by directly heating during printing.

Tear strength: Tear strength of the cured sample was measured at 25° C. according to ASTM D642. The details of the measuring conditions were listed in the tables 2-1 and 2-2. The cured sample was obtained by precuring at 25° C. for 12 hours, then post curing under heating condition for 1 hour. Or the cured sample was obtained by directly heating during printing.

Volume resistivity: measured according to GB/T 2439-2001 , equivalent to ISO1853: 1998. Test specimen has length of 10 cm, thickness of 2-3 mm and width of 1 cm. The two electrodes are fixed both ends of the test specimen. Then the testing is carried out at room temperature. The electrical resistivity can be obtained according to the above method. Finally, the volume resistivity can be obtained based on the formula,

$$ρ = R \frac{A}{l} ,$$

ρ is the volume resistivity, R is the electrical resistivity of a uniform specimen, A is the cross-sectional area of the specimen, l is the length of the specimen.

Table 2-1

Formulas and Test Results of the Addition-Crosslinking Electro-Conductive Silicone Compositions

| Raw Materials | | Example 1 | Example 2 | Example 3 | Example 4 | Comparative Example 1 | Comparative Example 2 | Comparative Example 3 |
|---|---|---|---|---|---|---|---|---|
| A-1 | | 14 | 14 | 14 | 31.5 | 0 | 0 | 7 |
| A-2 | | 14.06 | 21.06 | 21.06 | 16.06 | 34.07 | 23.76 | 24.06 |
| B-1 | | 2.2 | 2.2 | 2.2 | 2.2 | 2.2 | 0 | 2.2 |
| B-2 | | 0.7 | 0.7 | 0.7 | 0.7 | 0.7 | 0.2 | 0.7 |
| C-1 | | 0.02 | 0.02 | 0.02 | 0.02 | 0.02 | 0.02 | 0.02 |
| D-1 | | 6 | 6 | 6 | 13.5 | 0 | 0 | 3 |
| E-1 | | 2 | 2 | 0 | 2 | 2 | 2 | 2 |
| E-2 | | 0 | 0 | 2 | 0 | 0 | 0 | 0 |
| F-1 | | 57 | 50 | 50 | 30 | 57 | 70 | 57 |
| F-2 | | 0 | 0 | 0 | 0 | 0 | 0 | 0 |
| G-1 | | 0.3 | 0.3 | 0.3 | 0.3 | 0.3 | 0.3 | 0.3 |
| H-1 | | 3.72 | 3.72 | 3.72 | 3.72 | 3.72 | 3.72 | 3.72 |
| Total | | 100 | 100 | 100 | 100 | 100 | 100 | 100 |
| SiH/Si-vinyl ratio | | 3.8 | 3.79 | 3.79 | 2.6 | 8.4 | 1.96 | 5.3 |
| wt ratio of component D/F | | 0.105 | 0.12 | 0.12 | 0.45 | 0 | 0 | 0.053 |
| Test Results | | | | | | | | |
| viscosity η (mPa.s) at [0,5 s⁻¹] | 23° C. | 3080000 | 2000000 | 2900000 | 1910000 | 1400000 | NA | 1640000 |
| viscosity η (mPa.s) at [25 s⁻¹] | | 170000 | 161000 | 167000 | 117000 | 160000 | NA | 170000 |
| Thixotropic ratio | | 18.1 | 12 | 17 | 16 | 8.8 | NA | 9.6 |
| Status of mixture | | thixotropic | thixotropic | thixotropic | thixotropic | flowable | difficult to process | flowable |
| Hardness / Shore.A | 150° C. × 1 hour | 30 | 28 | 32 | 17 | 18 | NA | 18 |
| Tear strength/ N/mm | | 2.17 | 3 | 6.4 | 3.65 | 2.4 | NA | 1.7 |
| Tensile strength/ MPa | | 043 | 0.51 | 1.06 | 0.88 | 0.4 | NA | 0.3 |
| Elongation at break/% | | 314 | 285 | 141 | 387 | 162 | NA | 285 |
| Volume conductivity / Ω·cm | | 0.24 | 4.34 | 20 | 2 x 10⁹ | 0.3 | NA | 0.6 |

* NA means not applicable or not determined.

Table 2-2

Formulas and Test Results of the Addition-Crosslinking Electro-Conductive Silicone Compositions

| Raw Materials | | Example 5 | Example 6 | Comparative Example 4 | Comparative Example 5 |
|---|---|---|---|---|---|
| A-1 | | 14 | 14 | 14 | 14 |
| A-2 | | 54.46 | 67.76 | 70.06 | 51.06 |
| B-1 | | 1 | 0 | 2.2 | 2.25 |
| B-2 | | 3.5 | 1.2 | 0.7 | 0.7 |
| C-1 | | 0.02 | 0.02 | 0.02 | 0.02 |
| D-1 | | 6 | 6 | 6 | 6 |
| E-1 | | 2 | 2 | 2 | 2 |
| E-2 | | 0 | 0 | 0 | 0 |
| F-1 | | 0 | 0 | 0 | 0 |
| F-2 | | 15 | 5 | 1 | 20 10 |
| G-1 | | 0.3 | 0.3 | 0.3 | 0.3 |
| H-1 | | 3.72 | 3.72 | 3.72 | 3.72 |
| Total | | 100 | 100 | 100 | 100 |
| SiH/Si-vinyl ratio | | 1.8 | 2.29 | 2.22 | 2.58 |
| wt ratio of component D/F | | 0.4 | 1.2 | 6 | 0.3 |
| Test results | | | | | |
| viscosity η (mPa.s) at [0,5 s-1] | 23° C. | 2880000 | 763700 | 159200 | NA |
| viscosity η (mPa.s) at [25 s-1] | | 165000 | 169700 | 73140 | NA |
| Thixotropic ratio | | 17 | 4.5 | 2.2 | NA |
| Status of mixture | | thixotropic | thixotropic | flowable | difficult to process |
| Hardness / Shore.A | 150° C. ×1 hour | 30 | 21 | NA | NA |
| Tear strength/ N/mm | | 3.3 | 4.4 | NA | NA |
| Tensile strength/ MPa | | 0.8 | 0.56 | NA | NA |
| Elongation at break/% | | 30 | 256 | NA | NA |
| Volume conductivity / Ω·cm | | 3.8 | 59.5 | 2 × 10⁹ | NA |

* NA means not applicable or not determined.

According to table 2-1, compared with comparative examples 1~3, the inventive examples 1 ~4 exhibit better thixotropic property and show board range of conductivity. The same results can be obtained in the table 2-2 for inventive examples 5 to 6 compared with comparative example 4 and 5.

1. A method of additive manufacturing an object using a 3D printing apparatus, comprising the steps of:
1) applying an additive manufacturing material on a substrate with a 3D printer selected from an extrusion 3D printer or a material jetting 3D printer to form a first layer,
2) optionally applying onto the first layer one or more subsequent layer(s) of an additive manufacturing material, wherein the compositions of the materials of the first and subsequent layers are kept the same or different from each other, and
3) allowing the first and optional subsequent layers to crosslink, optionally by heating, to obtain an elastomer article,
wherein at least one layer or part of at least one layer is formed by an addition-crosslinking electro-conductive silicone composition comprising :
(A) at least one organopolysiloxane compound A comprising, per molecule at least two C₂-C₆ alkenyl radicals bonded to silicon atoms,
(B) at least one organohydrogenopolysiloxane compound B comprising, per molecule, at least two hydrogen atoms bonded to an identical or different silicon atom,
(C) at least one catalyst C comprising at least one metal from the platinum group or the compound thereof,
(D) at least one reinforcing silica filler D,
(E) at least one thixotropic agent which is selected from compounds having epoxy group, (poly)ether group, and/or (poly)ester group, organopolysiloxane having an aryl group and mixtures thereof;
(F) at least one electro-conductive filler F, which is selected from nickel coated carbon, optionally nickel coated graphite, graphene or mixtures thereof;
(G) optionally at least one crosslinking inhibitor G.

2. The method according to claim 1, wherein the reinforcing silica filler D has a content of 0.5-40 wt%, optionally 2-20 wt%, optionally 3-15 wt%, based on the total weight of addition-crosslinking electro-conductive silicone composition; and/or the weight ratio of reinforcing silica filler D to electro-conductive filler F in the composition is from 0.0001 to 100, from 0.001 to 50, from 0.01 to 10, optionally from 0.02 to 5, optionally from 0.05 to 3.

3. The method according to claim 1, wherein the addition-crosslinking electro-conductive silicone composition, based on the total weight of the composition, comprises:
(A) 5-95 wt.% of at least one organopolysiloxane compound A comprising, per molecule, at least two C₂-C₆ alkenyl radicals bonded to silicon atoms,
(B) 0.1-500 ppm of catalyst C, and/or
(C) from 0.01 wt%to 30 wt%, optionally 0.20 wt%to 10 wt%, optionally from 0.5 wt%to 7 wt%of thixotropic agent.

4. The method according to claim 1, wherein the electro-conductive filler F is a nickel-coated carbon particle, a nickel-coated carbon flake or a nickel-coated carbon fiber, but not the mixture thereof.

5. The method according to claim 1, wherein the electro-conductive filler F is nickel-coated carbon and in this case the weight ratio of reinforcing silica filler D to electro-conductive filler F in said addition-crosslinking electro-conductive silicone composition is from 0.0001 to 100, optionally from 0.01 to 10, optionally from 0.05 to 0.6.

6. The method according to claim 4, wherein the thixotropic index of said addition-crosslinking electro-conductive silicone composition is higher than 10, optionally higher than 11, optionally higher than 12.

7. The method according to claim 1, wherein said electro-conductive filler F is nickel-coated carbon flake with an average length of less than 200 µm, optionally less than 150 µm.

8. The method according to claim 1, where the electro-conductive filler F is a graphene and in this case the weight ratio of reinforcing silica filler D to electro-conductive filler F in the addition-crosslinking electro-conductive silicone composition is from 0.001 to 100, optionally from 0.1 to 10, optionally from 0.35 to 1.5.

9. The method according to claim 8, wherein the thixotropic index of said addition-crosslinking electro-conductive silicone composition is higher than 3, optionally higher than 3.5, optionally higher than 4.

10. The method according to claim 1, wherein the molar ratio of silicon-bonded hydrogen atoms (Si-H groups) to the sum of the silicon-bonded vinyl groups (Si-Vinyl groups) in whole composition is from 0.5 to 10 mol/mol, optionally from 0.8 to 5 mol/mol, optionally from 1 to 3 mol/mol.

11. The method according to claim 1, wherein the reinforcing silica filler D is subjected to hydrophobic surface treatment and optionally is fumed silica.

12. The method according to claim 1, wherein the addition-crosslinking electro-conductive silicone composition comprises, per 100% weight of the silicone composition:
from 20 to 95 wt% of at least one said organopolysiloxane compound A;
from 0.1 to 20 wt% of at least one said organohydrogenopolysiloxane compound B;
from 3 to 15 wt% of at least one said reinforcing silica filler D;
from 1 to 7 wt% of at least one said thixotropic agent;
from 0.1-500 ppm of said catalyst, optionally platinum; and
from 0.01 to 2 wt% of at least one said crosslinking inhibitor.
said electro-conductive filler F,
wherein the weight ratio of reinforcing filler D to electro-conductive filler F in the composition is from 0.05 to 3.

13. The method according to claim 1 wherein the 3D printer is an extrusion 3D printer or material jetting 3D printer.

14. The method according to claim 1 wherein the additive manufacturing material is a silicone composition.

15. An elastomer article produced by the method of claim 1.

16. The article according to claim 15, wherein the article is a silicone elastomer article.

17. A addition-crosslinking electro-conductive silicone composition as set forth in claim 1 for producing an electro-conductive element or part of it in electronics, automobiles, aerospace, high-speed railway, communication, electric power, medicine and wearable intelligent devices.
